(19) United States
(12) Patent Application Publication
(10) Pub. No.: US 2021/0319075 A1
(43) Pub. Date: Oct. 14, 2021

(54) DATA PROCESSING APPARATUS, DATA PROCESSING METHOD, AND COMPUTER-READABLE STORAGE MEDIUM

(71) Applicants: KABUSHIKI KAISHA TOSHIBA, Minato-ku (JP); TOSHIBA DIGITAL SOLUTIONS CORPORATION, Kawasaki-shi (JP)

(72) Inventors: Yoshisato SAKAI, Kawasaki (JP); Hayato GOTO, Kawasaki (JP); Kosuke TATSUMURA, Yokohama (JP)

(73) Assignees: KABUSHIKI KAISHA TOSHIBA, Minato-ku (JP); TOSHIBA DIGITAL SOLUTIONS CORPORATION, Kawasaki-shi (JP)

(21) Appl. No.: 17/356,667

(22) Filed: Jun. 24, 2021

Related U.S. Application Data
(63) Continuation of application No. 16/299,435, filed on Mar. 12, 2019.

(30) Foreign Application Priority Data
Jan. 21, 2019 (JP) 2019-008084

(51) Int. Cl. G06F 17/13

(52) U.S. Cl. CPC G06F 17/13

(57) ABSTRACT

According to one embodiment, a processor calculates values of variables in each step of a repetitive calculation using values of the variables calculated in a previous step, and determines whether a difference between the values of the variables calculated in each step and a particular value is larger than a first value. The processor corrects a value of the variables calculated in the previous step to be close to the particular value and calculates a value of the variables in the current step using a corrected value of the variables if the difference is larger than the first value.

### CROSS-REFERENCE TO RELATED APPLICATIONS

This application is a continuation of U.S. application Ser. No. 16/299,435, filed Mar. 12, 2019, which is based upon and claims the benefit of priority from Japanese Patent Application No. 2019-008084, filed Jan. 21, 2019, the entire contents of which are incorporated herein by reference.

### FIELD

Embodiments described herein relate generally to a data processing apparatus, a data processing method, and a computer-readable storage medium.

### BACKGROUND

In order to process and present a large number of values of variables in appropriate combination according to purpose, it may be desired to extract an optimum combination pattern from a large number of combination patterns of the values of variables. The extraction of the optimum combination pattern is said to be a combinatorial optimization problem.

A technique of solving the combinatorial optimization problem includes a method of determining a predetermined function calculating an evaluation value of the combination patterns. An optimum combination pattern is determined such that the evaluation value is a specific value (the maximum value, the minimum value, etc.). An example of the predetermined function includes Hamiltonian representing a total energy based upon an Ising model. The evaluation value may be calculated by modifying the Ising model.

The size of the Ising model becomes large in many applications. If the size of the Ising model is large, the number of variables is also large so that time required for solving the combinatorial optimization problem is long and the accuracy of the calculation is low.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing an example of a data processing apparatus according to the embodiment.

FIG. 2 is a flowchart schematically showing an example of an operation of the data processing apparatus.

FIG. 3 is a flowchart schematically showing an example of step S106 of FIG. 2 in which the values of the variables are calculated.

FIG. 4 is an illustration of calculating the values of the variables using a recurrence equation.

FIG. 5 shows a first example of correcting the value of the first variable during the repetitive calculation.

FIG. 6 shows a second example of correcting the value of the first variable during the repetitive calculation.

FIG. 7 shows a third example of correcting the value of the first variable during the repetitive calculation.

FIG. 8 shows a fourth example of correcting the value of the first variable during the repetitive calculation.

FIG. 9 shows a fifth example of correcting the value of the first variable during the repetitive calculation.

FIG. 10 shows a sixth example of correcting the value of the first variable during the repetitive calculation.

FIG. 11 shows a seventh example of correcting the value of the first variable during the repetitive calculation.

FIG. 12 shows an example of the relationship between the number of repetitions of the repetitive calculation and the values of the first variable without correcting the value.

FIG. 13 shows a first example of the relationship between the number of repetitions of the repetitive calculation and the values of the first variable when the value is corrected as shown in FIG. 7.

FIG. 14 shows a second example of the relationship between the number of repetitions of the repetitive calculation and the values of the first variable when the value is corrected as shown in FIG. 8.

FIG. 15 shows a third example of the relationship between the number of repetitions of the repetitive calculation and the values of the first variable when the value is corrected as shown in FIG. 10.

FIG. 16 shows a fourth example of the relationship between the number of repetitions of the repetitive calculation and the values of the first variable when the value is corrected as shown in FIG. 11.

### DETAILED DESCRIPTION

Various embodiments will be described hereinafter with reference to the accompanying drawings. The disclosure is merely an example, and the invention is not limited by the contents described in the following embodiments. It is a matter of course that modifications easily conceivable by those skilled in the art are included in the scope of the disclosure. A size, a shape, and the like of each part are sometimes changed from those of an actual embodiment and schematically represented in the drawings in order to further clarify the description. In the drawings, corresponding elements are denoted by the same reference numerals, and a detailed description thereof is omitted in some cases.

In general, according to one embodiment, a data processing apparatus includes an input device that inputs variables and a processor. The processor is configured to repetitively calculate values of the variables in each calculation step of a repetitive calculation using values of the variables calculated in a previous calculation step of the repetitive calculation, and determine whether a difference between each of the values of the variables calculated in each calculation step and a particular value is larger than a first value. The processor is configured to calculate a value of the variables in a current calculation step of the repetitive calculation using a value of the variables calculated in the previous calculation step if the difference between the value of the variables calculated in the previous calculation step and the particular value is not larger than the first value. The processor is configured to correct the value of the variables calculated in the previous calculation step to be close to the particular value and calculate a value of the variables in the current calculation step using a corrected value of the variables if the difference between the value of the variables calculated in the previous calculation step and the particular value is larger than the first value.

According to the embodiment, the combinatorial optimization problem is solved by utilizing the concept of the Ising model for use in condensed-matter physics.

Hamiltonian H (energy function) used in the Ising model is a function defined in condensed-matter physics based on quantum mechanics.

According to embodiment, a variable (e.g., momentum y) in which the concept (model) of kinetic energy and momentum for use in classical mechanics (classical model) is used and properties of the classical mechanics is effectively utilized.

First, an Ising problem will be described.

For example, Ising energy E_{Ising} is expressed by Eq. 1.

$${E}_{Ising} = - \frac{1}{2} {\sum }_{i = 1}^{N} {\sum }_{j = 1}^{N} {J}_{ij} {s}_{i} {s}_{j} + {\sum }_{i = 1}^{N} {h}_{i} {s}_{i} \qquad Eq . 1$$

In Eq. 1, N represents the number of Ising spins. Variable sᵢ (i=1 to N) represents the Ising spin. The value of Ising spin sᵢ is defined as +1 or −1.

Coefficient Jᵢⱼ is a component of a real symmetric matrix J in which the diagonal components (diagonal elements) are all zero.

A physics model represented by Eq. 1 is called an Ising model. According to an Ising problem as one example of combinatorial optimization problem, a combination of values of variables sᵢ (N values of spins) as +1 or −1 in which the value of E_{Ising} is minimum is obtained.

Quantum bifurcation machine or classical mechanic model of quantum bifurcation machine (hereinafter, called classical bifurcation machine) is proposed to solve the Ising problem.

In the classical bifurcation machine, the kinetic formulae are given by Eq. 2, Eq. 3, and Eq. 4. First variable xᵢ represents a position and second variable yᵢ represents a momentum.

$$\begin{matrix} \frac{{dx}_{i}}{dt} = \frac{\partial H}{\partial {y}_{i}} = {y}_{i} \{ D + p ( t ) + K ( {x}_{i}^{2} + {y}_{i}^{2} ) \} - c {\sum }_{j = 1}^{N} {J}_{ij} {y}_{j} & Eq . 2 \\ \frac{{dy}_{i}}{dt} = - \frac{\partial H}{\partial {x}_{i}} = {x}_{i} \{ - D + p ( t ) - K \{ {x}_{i}^{2} + {y}_{i}^{2} ) \} - {ch}_{i} a ( t ) + c {\sum }_{j = 1}^{N} {J}_{ij} {x}_{j} & Eq . 3 \\ H = {\sum }_{i = 1}^{N} [ \frac{D}{2} ( {x}_{i}^{2} + {y}_{i}^{2} ) - \frac{p ( t )}{2} ( {x}_{i}^{2} - {y}_{i}^{2} ) + \frac{K}{4} {( {x}_{i}^{2} + {y}_{i}^{2} )}^{2} + {ch}_{i} {x}_{i} a ( t ) - \frac{c}{2} {\sum }_{j = 1}^{N} {J}_{ij} ( {x}_{i} {x}_{j} + {y}_{i} {y}_{j} ) ] & Eq . 4\end{matrix}$$

In Eq. 2, Eq. 3, and Eq. 4, D represents a coefficient corresponding to quantum levels, c is a constant, p(t) represents a coefficient corresponding to a pump rate, and K represents a car coefficient. These values may be set in advance. Coefficient hᵢ may be excluded from Eq. 3 and Eq. 4. In this case, the terms including coefficient hᵢ are ignored.

In Eq. 2, Eq. 3, and Eq. 4, a value (+1 or −1) that is obtained by binarizing a final value of the first variable xᵢ when coefficient p(t) is increased from zero to a sufficiently large value is Ising spin sᵢ which is a solution of the Ising problem (basic state). Coefficient a(t) that increases with coefficient p(t) is expressed by, for example, Eq. 5.

a(t)=\sqrt{p(t)/K} Eq. 5

For convenience of description, coefficient K is set to 1, but may be set to any number other than 1.

The above classical bifurcation machine utilizes Hamiltonian mechanics. In Eq. 4, H represents Hamiltonian. When the kinetic formulae are solved by a digital computer, it is possible to solve the Ising problem as one example of combinatorial optimization problem.

There is simulated annealing as a method for solving the combinatorial optimization problem. This method employs a recurrent modification algorithm. In the recurrent modification algorithm, a plurality of spins are modified one by one. Thus, the recurrent modification algorithm is not suitable for parallel calculation.

In contrast, when the kinetic formulae of the classical bifurcation machine are solved by a digital computer, high-speed data processing can be expected by parallel calculation since it is easy to modify a plurality of spins at the same time.

According to Eq. 2 to Eq. 5, it is necessary to calculate matrix J which requires a large amount of calculation when the first variable xᵢ and the second variable yᵢ are updated.

According to the embodiment, therefore, the simultaneous ordinary differential equations represented by Eq. 2, Eq. 3, and Eq. 4 are transformed into those as represented by Eq. 6, Eq. 7, and Eq. 8 in order to decrease an amount of calculation. The parallel modify algorithm is performed based upon Eq. 6, Eq. 7, and Eq. 8. In Eq. 8, H′ also represents Hamiltonian.

$$\begin{matrix} \frac{{dx}_{i}}{dt} = \frac{\partial {H}^{′}}{\partial {y}_{i}} = {Dy}_{i} & Eq . 6 \\ \frac{{dx}_{i}}{dt} = - \frac{\partial {H}^{′}}{\partial {x}_{i}} = \{ - D + p ( t ) - {Kx}_{i}^{2} \} {x}_{i} - {ch}_{i} {a}_{i} ( t ) + c {\sum }_{j = 1}^{N} {J}_{ij} {x}_{j} & Eq . 7 \\ {H}^{′} = {\sum }_{i = 1}^{N} [ \frac{D}{2} ( {x}_{i}^{2} + {y}_{i}^{2} ) - \frac{p ( t )}{2} {x}_{i}^{2} + \frac{K}{4} {x}_{i}^{4} + {ch}_{i} {x}_{i} {a}_{i} ( t ) - \frac{c}{2} {\sum }_{j = 1}^{N} {J}_{ij} {x}_{i} {x}_{j} ] & Eq . 8\end{matrix}$$

Similar to Eq. 3 and Eq. 4, coefficient hᵢ may be excluded from Eq. 7 and Eq. 8. In this case, the terms including coefficient hᵢ are ignored.

As expressed by Eq. 6 and Eq. 7, a product-sum operation for matrix J is necessary for updating the second variable yᵢ (dyᵢ/dt) and is not necessary for updating the first variable xᵢ (dxᵢ/dt). The product-sum operation for matrix J requires a large amount of calculation. Therefore, according to the embodiment, an amount of calculation is decreased. Further, a time differential (dxᵢ/dt) of the first variable xᵢ includes the second variable yᵢ but does not include the first variable xᵢ. A time differential (dyᵢ/dt) of the second variable yᵢ includes the first variable xᵢ but does not include the second variable yᵢ. Thus, the variable xᵢ is separated from the variable yᵢ so that the discrete solving method can be used to solve Eq. 6, Eq. 7, and Eq. 8. An amount of calculation of the discrete solving method is small and an operation state of the discrete solving method is stable. An example of the discrete solving method includes the symplectic Euler method. As shown in Eq. 6, pump rate p(t) is not included in in the time differential (dxᵢ/dt) of the first variable xᵢ.

Using the foregoing method, a high performance (e.g., high accuracy) data processing can be achieved. In the data processing apparatus according to the embodiment, the kinetic formulae of the Hamilton mechanics system (new classical bifurcation machine) with the above-described separable Hamiltonian are solved using, for example, the symplectic Euler method. The data processing apparatus according to the embodiment is so configured that a new algorithm can be performed by parallel calculation as fast as possible.

In Eq. 6, Eq. 7, and Eq. 8, a value (+1 or −1) that is obtained by binarizing a final value of the first variable xᵢ when coefficient p(t) is increased from zero to a sufficiently large value is Ising spin sᵢ which is a solution of the Ising problem (basic state). If the final value of the first variable xᵢ is positive, the value of Ising spin sᵢ is +1. If the final value of the first variable xᵢ is negative, the value of Ising spin sᵢ is −1.

The value of the first variable xᵢ and the value of the second variable yᵢ are set to appropriate initial values. For example, these variables may be minute values, for example, smaller than 0.1 (absolute value).

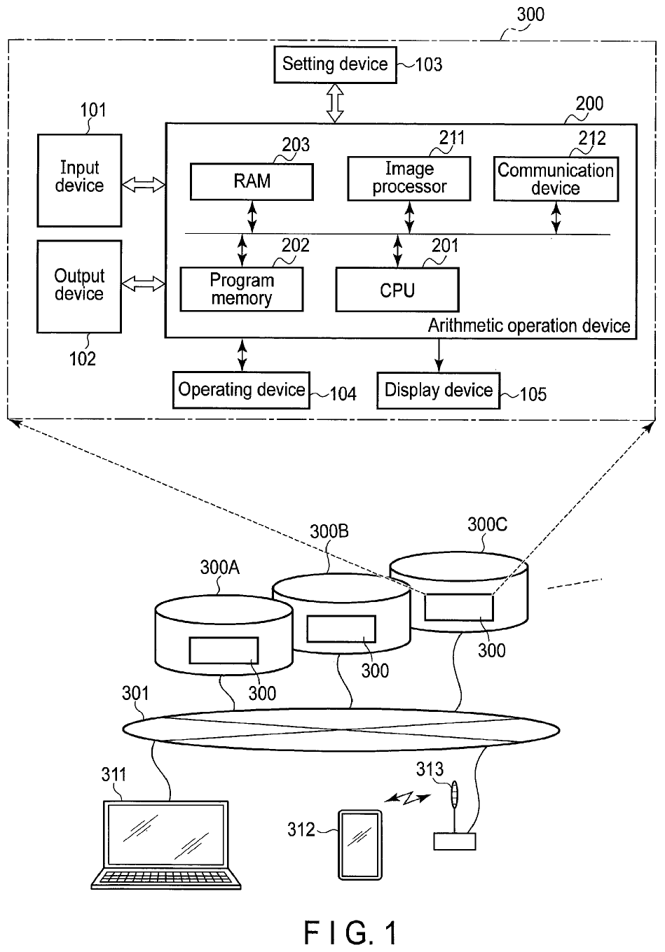

FIG. 1 is a block diagram showing an example of a data processing apparatus 300 according to the embodiment and an example of a configuration of a system including the apparatus 300. The data processing apparatus 300 may be, for example, a workstation and a personal computer. The data processing apparatus 300 may include an input device 101, an output device 102, a setting device 103, an arithmetic operation device 200, an operating device 104, and a display device 105. Note that only the arithmetic operation device 200 may be referred to as a data processing unit.

The input device 101, the output device 102, the setting device 103, or the arithmetic operation device 200 may be called a portion, a system, or a unit.

The arithmetic operation device 200 includes a digital hardware processor (CPU) 201, a program memory 202, a random access memory (RAM) 203, an image processor 211, and a communication device 212. The RAM 203 temporarily stores data and the like. The CPU 201 performs arithmetic operation in accordance with a program stored in the program memory 202.

The setting device 103 sets the values of various coefficients (D, K, c, hᵢ, Jᵢⱼ, etc.) included in Eq. 8. The setting device 103 also sets the values of coefficients p(t) and a(t) included in Eq. 8, which vary (increase) as time passes.

When the values of the coefficients in the Eq. 8 are set, the CPU 201 repeats a calculation process using the recurrence equation based on Eq. 6 and Eq. 7 and obtains the values of the first variable xᵢ and the second variable yᵢ in which the value of evaluation function H′ represented by Eq. 8 is a minimum value.

The operations of the coefficient setting, calculation based on the recurrence equation, and input/output process are controlled by the operating device 104 such as a keyboard. The display device 105 displays the progress of processes performed in sequence or the final result of the processes.

The image processor 211 generates image data that seems to indicate the progress of data processing virtually. The generated image can be in various forms based on the intention of a system designer. For example, the display device 105 displays the progress of program processing in a bar graph and also displays the arrangement of the values of the variables imaginatively like a celestial globe or an armillary sphere.

The communication device 212 communicates with an external device. If at least one of the operating device 104, the display device 105, the setting device 103, the input device 101, and the output device 102 is arranged in a remote area, the data are received from the remote device or transmitted to the remote device via a communication line of the communication device 212.

The number of the first variables xᵢ included in the evaluation function H′ of Eq. 8 is N. Among the first variables xᵢ, a particular number of the first variables (only m-th variable xₘ or two or more variables xₘ, xₙ or more) may be selected and the value of the selected variable or the values of the selected variables may be output from the output device 102 as the solution of the combinatorial optimization problem. The solution of the combinatorial optimization problem is not limited to the above. For example, a value of results obtained by performing a specific arithmetic operation for the m-th variable xₘ and n-th variable xₙ may be output from the output device 102.

It is assumed that coefficients c and a(t) included in Eq. 8 are both set to positive values. When a positive (or a negative) value is set to coefficient hᵢ, the value of the evaluation function H′ of Eq. 8 is decreased when a negative (or a positive) value is set to the first variable xᵢ. In other words, the value (+1 or −1) of the first variable xᵢ depends on the value of coefficient hᵢ.

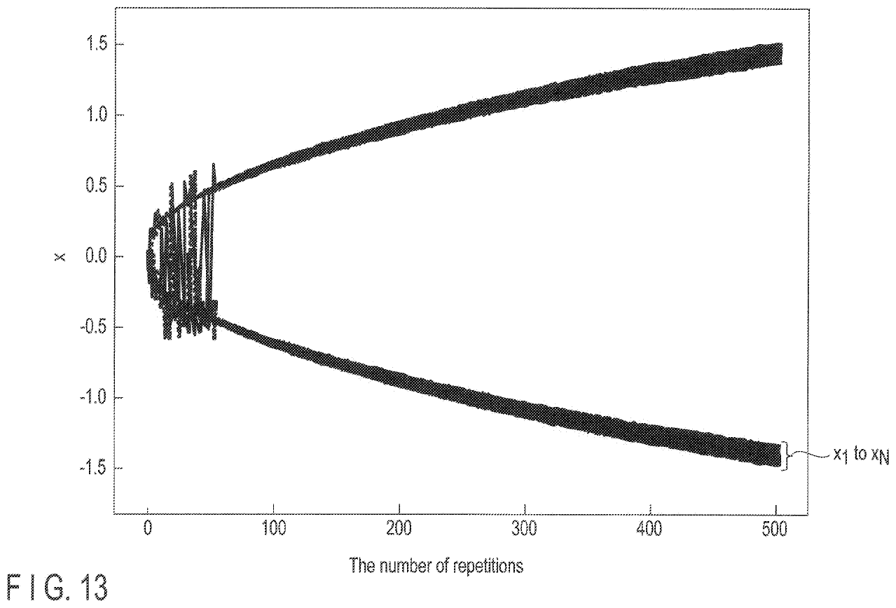

The data processing apparatus 300 may be a standalone type or part of servers 300A, 300B, and 300C. The servers 300A, 300B, and 300C can exchange data with one another via a network 301. The servers 300A, 300B, and 300C may receive data from a personal computer 311 via the network 301 and from a mobile terminal (e.g., a smart phone) 312 and transmit various graphs and data items or image data, such as graphs illustrating the processing results shown in FIG. 13 to FIG. 16 to be described later, to the personal computer 311 and the mobile terminal 312. The smart phone 312 can be connected to the network 301 via a base station 313.

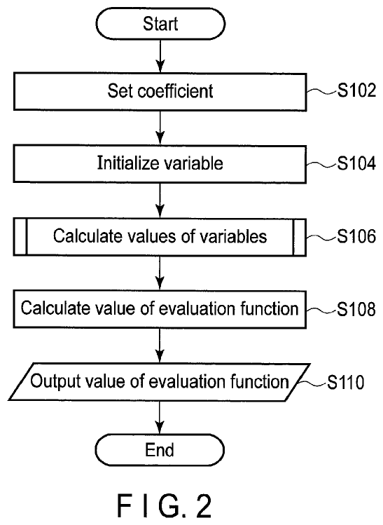

FIG. 2 is a flowchart schematically showing an example of an operation of the data processing apparatus 300. Steps shown in FIG. 2 each corresponds to a process to be performed by the CPU 201 based on the programs. The process may be achieved by a dedicated hardware block and, in this case, FIG. 2 can be regarded as a block diagram showing a combination of hardware blocks that form the data processing apparatus 300.

In step S102, the input device 101 inputs data indicating the values of coefficients from an external device, and the setting device 103 sets the values of coefficients based on the input data.

In step S104, the setting device 103 initializes the first variable xᵢ and the second variable yᵢ. For example, the initial values of the first variable xᵢ and the second variable yᵢ may be initialized to minute values by using random numbers. Steps S102 and S104 may be performed in reverse order or in parallel.

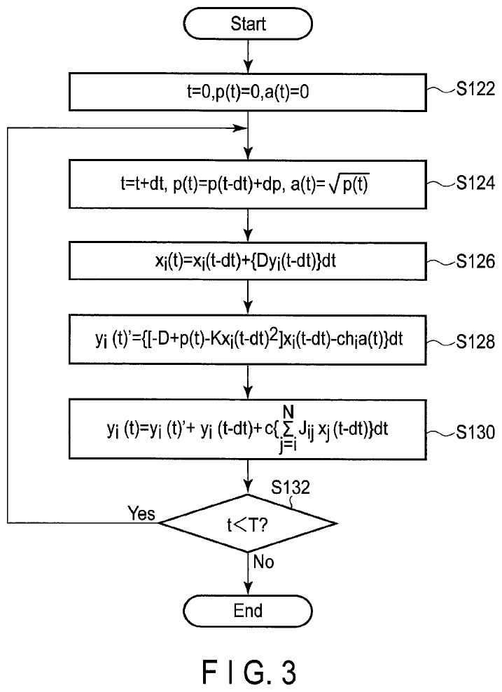

In step S106, the CPU 201 calculates N values of the first variables xᵢ and N values of the second variables yᵢ based on the simultaneous ordinary differential equations of Eq. 6 and Eq. 7. The values obtained in the middle of the calculation may be binarized. For example, when an analog value of the first variable xᵢ is 0 or more, the binarized value may be +1. When an analog value of the first variable xᵢ is smaller than 0, the binarized value may be −1. The details of step S106 are illustrated in FIG. 3.

In step S108, the CPU 201 substitutes the values of the first variable xᵢ and the second variable yᵢ obtained in step S106 into Eq. 8 to calculate the value of the evaluation function H′.

In step S110, the output device 102 outputs the value of the evaluation function H′ calculated in step S108. The output device 102 may output not only the value of the evaluation function H′ but also the values of the first variable xᵢ and the second variable yᵢ finally obtained.

FIG. 3 illustrates an example of variable calculation step S106 of FIG. 2. In step S122, the setting device 103 set time t to 0 and the values of coefficients p(t) and a(t) to 0.

In step S124, the setting device 103 increases time t by dt and the value of coefficient p(t) by dp. Coefficient a(t) is expressed by Eq. 5 so that the value of coefficient a(t) is also increased in accordance with the increase of coefficient p(t).

In step S126, the CPU 201 calculates a value of the first variable xᵢ of the simultaneous ordinary differential equations of Eq. 6 based on a recurrence equation. Eq. 6 is transformed into the recurrence equation shown in Eq. 6A.

$$\frac{{x}_{i} ( t ) - {x}_{i} ( t - dt )}{dt} = {Dy}_{i} ( t - dt ) \qquad Eq . 6 A$$

The recurrence equation of Eq. 6A is further transformed into the recurrence equation shown in Eq. 6B.

xᵢ(t)=xᵢ(t−dt)+{Dyᵢ(t−dt)}dt Eq. 6B

The recurrence equation shown in Eq. 6B indicates a relationship between the value of the first variable xᵢ(t−dt) calculated at a previous timing “t−dt” and a value of the first variable xᵢ(t) to be calculated at the present timing “t”.

In step S126, the CPU 201 calculates a value of the first variable xᵢ(t) by using the recurrence equation shown in Eq. 6B. The CPU 201 calculates a value of the variable xᵢ(t) in a current calculation step of the repetitive calculation using a value of the variable xᵢ(t−dt) calculated in the previous calculation step.

Eq. 7 relating to the second variable yᵢ is transformed into the recurrence equation shown in Eq. 7A.

$$\frac{{y}_{i} ( t ) - {y}_{i} ( t - dt )}{dt} = ( - D + p ( t ) - {{kx}_{i} ( t - dt )}^{2} ) {x}_{i} ( t - dt ) - {ch}_{i} a ( t ) + c {\sum }_{j = 1}^{N} {J}_{ij} {x}_{j} ( t - dt ) \qquad Eq . 7 A$$

The recurrence equation of Eq. 7A is further transformed into the recurrence equation shown in Eq. 7B.

$${y}_{i} ( t ) = {y}_{i} ( t - dt ) + \{ [ - D + p ( t ) - {{kx}_{i} ( t - dt )}^{2} ] {x}_{i} ( t - dt ) - {ch}_{i} a ( t ) + c {\sum }_{j = 1}^{N} {J}_{ij} {x}_{j} ( t - dt ) \} dt \qquad Eq . 7 B$$

The recurrence equation shown in Eq. 7B indicates a relationship between the value of the second variable yᵢ(t−dt) calculated at a previous timing “t−dt” and a value of the second variable yᵢ(t) to be calculated at the present timing “t”.

In steps S128 and S130, the CPU 201 calculates a value of the second variable yᵢ(t) by using the recurrence equation shown in Eq. 7B. The CPU 201 calculates a value of the variable yᵢ(t) in a current calculation step of the repetitive calculation using a value of the variable yᵢ(t−dt) calculated in the previous calculation step.

A large amount of calculation is required to calculate the third term of the right-hand side of Eq. 7B. Thus, the calculation of Eq. 7B is divided into two portions as shown in steps S128 and S130. In step S128, the CPU 201 calculates the first and the second terms of the right-hand side of Eq. 7A. In step S130, the CPU 201 calculates the third term of the right-hand side of Eq. 7A. The value of the second variable yᵢ(t) is obtained based on the calculation result of step S128, the third term of the right-hand side of Eq. 7A, and the previous value yᵢ(t−dt).

The calculation of the values of the first variable xᵢ and the second variable yᵢ is repeated with increasing time t and the values of coefficients p(t) and a(t) until time t becomes larger than T (t>T) (YES in step S132).

When time t becomes larger than T, the values of coefficients p(t) and a(t) become equal to 1.

In the flowchart of FIG. 3, the values of the first variable xᵢ is calculated first. It is possible to calculate the second variable yᵢ first. Further, it is possible to calculate the values of the first variable xᵢ and the values of the second variable yᵢ in parallel.

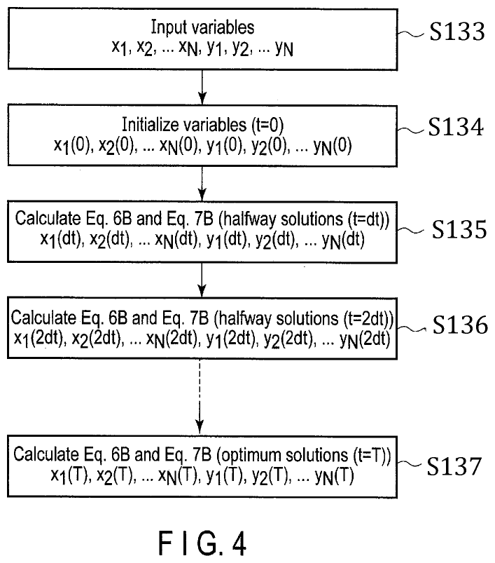

FIG. 4 is an illustration of visualization of a calculation process based on the recurrence equation of Eq. 6B and Eq. 7B to calculate solutions of the simultaneous ordinary differential equations of Eq. 6 and Eq. 7. In step S142, the first variable xᵢ and the second variable yᵢ are input. In step S144, the first variable xᵢ and the second variable yᵢ are initialized. The initial values of the first variable xᵢ at time t=0 are expressed by x₁(0), x₂(0), . . . x_{N}(0). The initial values of the second variable yᵢ at time t=0 are expressed by y₁(0), y₂(0), . . . y_{N}(0). The initial values of the first variable xᵢ and the second variable yᵢ may be all 0. Steps S142 and S144 correspond to step S104 of FIG. 2.

In step S146, the first values xᵢ(dt), x₂(dt), . . . xᵢ(dt) of the first variable xᵢ in a first calculation step of the repetitive calculation (time t=dt) are calculated based on the initial values of the first variable xᵢ and the initial values of the second variable yᵢ and using the recurrence equation of Eq. 6B. For example, the first value xᵢ(dt) is obtained as xᵢ(0)+{Dyᵢ(0)}dt. The first values yᵢ(dt), y₂(dt), . . . y_{N}(dt) of the second variable yᵢ in the first calculation step are calculated based on the initial values of the first variable xᵢ and the initial values of the second variable yᵢ and using the recurrence equation of Eq. 7B.

In step S148, the second values x₁(2dt), x₂(2dt), . . . x_{N}(2dt) of the first variable xᵢ in a second calculation step of the repetitive calculation (time t=2dt) are calculated based on the first values of the first variable xᵢ and the first values of the second variable yᵢ and using the recurrence equation of Eq. 6B. For example, the second value xi(2dt) is obtained as xᵢ(dt)+{Dyᵢ(dt)}dt. The second values yᵢ(2dt), y₂(2dt), . . . y_{N}(2dt) of the second variable yᵢ in the second calculation step are calculated based on the first values of the first variable xᵢ and the first values of the second variable yᵢ and using the recurrence equation of Eq. 7B. The calculation of the recurrence equation in each calculation step is repeated with increasing time t by dt.

Finally, in step S150, the values x₁(T), x₂(T), . . . x_{N}(T) of the first variable xᵢ in a final calculation step (time t=T) are calculated using the recurrence equation of Eq. 6B. For example, the final value xi(T) is obtained as xᵢ(T−dt)+{Dyᵢ(T−dt)}dt. The values yᵢ(T), y₂(T), . . . y_{N}(T) of the second variable yᵢ in the final calculation step are calculated using the recurrence equation of Eq. 7B.

The embodiment can be modified as follows. The general combinatorial optimization problems are subjected to a number of constraints. The constraint term is considered when the evaluation function is defined.

This brings about the advantage of avoiding constraint violation. In the following description, variable sᵢ are used as the first variables xᵢ. Both variables are substantially the same.

An example of the combinatorial optimization problems is a traveling salesman problem. It is assumed that a salesman visits plural houses and there is a constraint that the salesman visits one house at a moment. The solution of the traveling salesman problem is to obtain an optimum route in which the moving distance of the salesman is minimum.

When the combinatorial optimization problems is solved by utilizing the Ising model, it is necessary to incorporate the constraint term into the evaluation function in addition to the moving distance. The value of the constraint term is large for a combination (a visiting route of the salesman) corresponding to an unsatisfied condition that a certain house is not visited. When the value of the evaluation function including the constraint term becomes minimum, a solution can be obtained in which the moving distance is minimum while satisfying the constraint condition.

It is assumed that the salesman visits 20 houses in order and the visiting order is determined by using an Ising model with 400 Ising spins sₖ (k=1 to 400).

The 20 houses are numbered as the first house to twentieth house. An Ising spin sₖ (k=20(i−1)+j) represents whether or not the i-th house is visited in the j-th order. If the value of the Ising spin sₖ is 1, the i-th house is visited in the j-th order. If the value of the Ising spin sₖ is −1, the i-th house is visited in the order other than the j-th order.

According to the traveling salesman problem, the constraint condition is that the number of visits by the salesman to the first house is 1 (the salesman visits one house at a moment and never visits the same house twice or more) is expressed by the following equation indicating that the total values of the Ising spins S₁ to S₂₀ is −18.

$${\sum }_{k = 1}^{20} {S}_{k} + 18 = 0$$

Similarly, the constraint condition is that the number of visits by the salesman to the i-th house is 1 (the salesman visits one house at a moment and never visits the same house twice or more) is expressed by the following equation indicating that the total values of the Ising spins S₂₀₍ᵢ₋₁₎₊₁ to S₂₀ᵢ is −18.

$${\sum }_{k = 20 ( i - 1 ) + 1}^{20 i} {s}_{k} + 18 = 0$$

Since Eq. 1 representing the Ising model is a quadratic equation, the constraint term for the first house is transformed as follows.

$${\{ {\sum }_{k = 1}^{20} {s}_{k} + 18 \}}^{2} is minimum .$$

The constraint term for the i-th house is transformed as follows.

$${\{ {\sum }_{k = 20 ( i - 1 ) + 1}^{20 i} {s}_{k} + 18 \}}^{2} is minimum .$$

To consider a balance between the constraint term and other terms, coefficient may be added to the constraint term.

As described above, it is assumed that the value of the spin sₖ are exactly +1 or −1 to determine the constraint term. According to the embodiment, to determine the value of the spin sₖ, the value of the first variable xᵢ is calculated by solving the simultaneous ordinary differential equations and the sign of the value of the first variable xᵢ is utilized as the value of the spin sₖ.

The classical bifurcation machine is not equipped with a mechanism for satisfying the constraint condition. According to the classical bifurcation machine, an ideal value of the variable xᵢ may not be exactly +1 or −1. If the value of the spin is calculated based on the ideal value of the variable xᵢ which is shifted from +1 or −1, the value of the variable xᵢ may not satisfy the constraint condition.

An ideal value of the variable xᵢ is a(t) or −a(t). The ideal value corresponds to a fixed point (excluding a variation component and not varied with time) when a(t) is assumed as a constant, as explained below.

$$\frac{{dy}_{i}}{dt} = - \frac{\partial {H}^{′}}{\partial {x}_{i}} = \{ - D + p ( t ) - {Kx}_{i}^{2} \} {x}_{i} - {ch}_{i} a ( t ) + c {\sum }_{j = 1}^{N} {J}_{ij} {x}_{j} \qquad Eq . 9$$

When the right-hand side of the Eq. 9 (the same as Eq. 7) is 0, the following equation Eq. 10 is obtained. The value of the variable xᵢ at the fixed point is obtained as a condenser thereof.

$$\{ - D + p ( t ) - {Kx}_{i}^{2} \} {x}_{i} - {ch}_{i} a ( t ) + c {\sum }_{j = 1}^{N} {J}_{ij} {x}_{j} = 0 \qquad Eq . 10$$

Assume that the constant c is given by the following Eq. 11 using the maximum eigenvalue λₘₐₓ of matrix J.

c=D/Iₘₐₓ Eq. 11

Since the maximum value of the Rayleigh quotient (Eq. 12 is λₘₐₓ, the following equation Eq. 13 when the value of the variable xᵢ is close to a point where the maximum value is given.

$$\begin{matrix}\frac{{\sum }_{i = 1}^{N} {\sum }_{j = 1}^{N} {J}_{ij} {x}_{i} {x}_{j}}{{\sum }_{i = 1}^{N} {\sum }_{j = 1}^{N} {x}_{i} {x}_{j}} & Eq . 12 \\ - {Dx}_{i} + c {\sum }_{j = 1}^{N} {J}_{ij} {x}_{j} \approx 0 & Eq . 13\end{matrix}$$

Considering the following equation Eq. 14, it has three solutions as given by the following equation Eq. 15.

(p(t)−Kxᵢ²)xᵢ=0 Eq, 14

xᵢ=0, xᵢ=±\sqrt{p(t)/K}±a(t) Eq. 15

Since “xᵢ=0” is an unstable fixed point, one of “xᵢ=+a(t)” and “xᵢ=−a(t)” is a solution.

When h is equal to 0 (h=0), the point that satisfies both Eq. 13 and Eq. 14 also satisfies Eq. 10 and thus the fixed point of the Eq. 9. It is confirmed by an experience that the activated position (appropriate position) x of the classical bifurcation machine) remains close to the fixed point. If the fixed point satisfies Eq. 13, the fixed point makes the values of Eq. 13, Eq. 14, and the following equation Eq. 16 minimum.

$$- \frac{1}{2} {\sum }_{i = 1}^{N} {\sum }_{j = 1}^{N} {J}_{ij} {x}_{i} {x}_{j} \qquad Eq . 16$$

Stated another way, finding the activated position (appropriate position) x of Eq. 9 is to find a point in which

$$- \frac{1}{2} {\sum }_{i = 1}^{N} {\sum }_{j = 1}^{N} {J}_{ij} {x}_{i} {x}_{j} is approximately minimum \\ where {x}_{i} ( t ) = \pm a ( t ) . \qquad Eq . 17$$

Even if h≠0, it is assumed that xi (t)=+a(t) and xi (t)=−a(t) satisfying the following equation Eq. 19 also satisfy the fixed point condition and the following equation Eq. 20 (strictly the value of c may be adjusted).

$$\begin{matrix}- {Dx}_{i} - {ch}_{i} a ( t ) + c \frac{1}{2} {\sum }_{j = 1}^{N} {J}_{ij} {x}_{j} \approx 0 and \{ p ( t ) - K {x}_{i}^{2} \} {x}_{i} = 0 & Eq . 18 \\ - \frac{1}{2} {\sum }_{i = 1}^{N} {\sum }_{j = 1}^{N} {J}_{ij} {x}_{i} {x}_{j} + {\sum }_{i = 1}^{N} {h}_{i} {x}_{j} is approximately minimum \\ where {x}_{i } ( t ) = \pm a ( t ) & Eq . 19\end{matrix}$$

As described above, the ideal value of the variable xᵢ is a(t) or −a(t). According to the embodiment, if the value of the variable xᵢ is shifted from the idle value, the value of the variable xᵢ is corrected to be the idle value. Since K is assumed to be 1, a(t) is \sqrt{p(t)}. Therefore, the idle value of the variable xi can be expressed as the following equation Eq. 20.

xᵢ(t)=±\sqrt{p(t)} Eq. 20

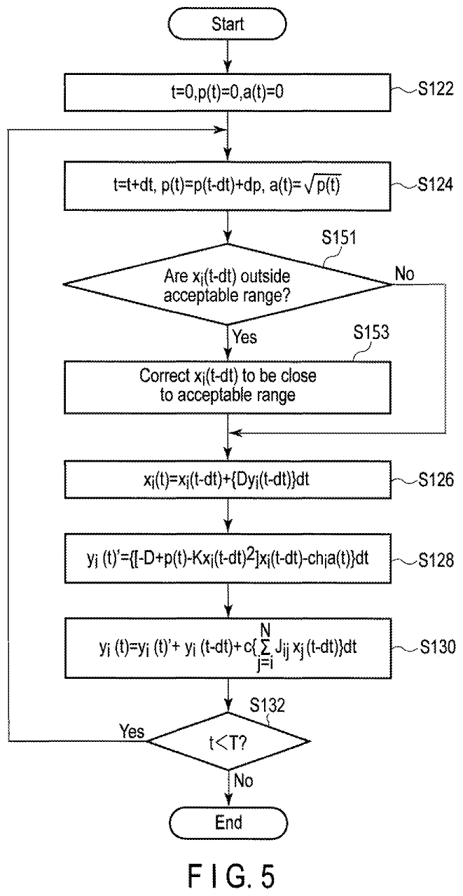

FIG. 5 to FIG. 11 are flow charts showing examples of calculation of the values of the first variable xᵢ and the second variable yᵢ including correction of the value of the variable xᵢ. FIG. 5 to FIG. 11 correspond to a modification of FIG. 3. Steps in FIG. 5 to FIG. 11 corresponding to steps in FIG. 3 are denoted by the same reference numerals and their detailed description will be omitted.

FIG. 5 shows the first example of correction. In the first example, after the increment step S124, the CPU 201 determines whether or not the value of the variable xᵢ(t−dt) calculated in the previous calculation step of the repetitive calculation is outside an acceptance range in step S151. The acceptance range is determined using based on −\sqrt{p(t−dt)} and +\sqrt{p(t−dt)}. If it is inside the acceptance range (No in step S151), the CPU 201 calculates the value of the variable xᵢ(t) in the current calculation step in step S126.

If it is outside the acceptance range (Yes in step S151), the CPU 201 corrects the value of the variable xᵢ(t−dt) to be close or inside the acceptance range in step S153. After the correction step S153, the CPU 201 calculates the value of the variable xᵢ(t) in step S126, based on the corrected value. The correction can be performed by a particular hardware in the arithmetic operation device 200.

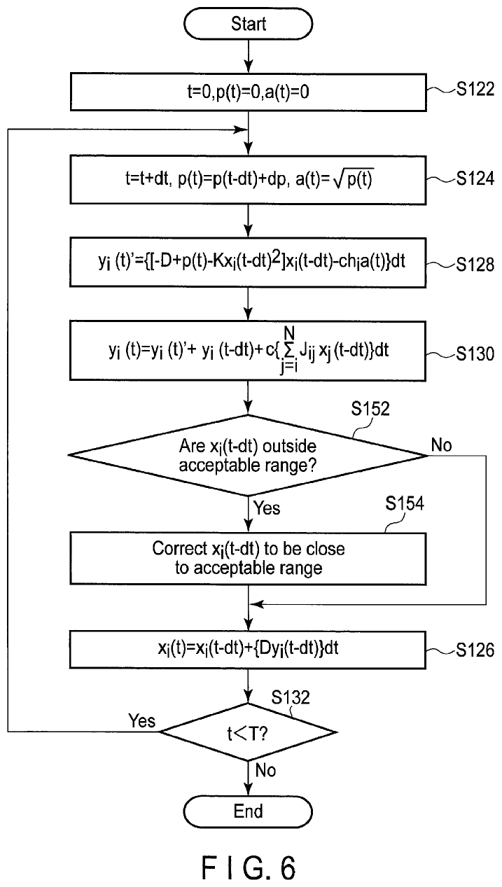

In the first example of FIG. 5, the correction is performed before the repetitive calculation of the variables. The correction can be performed during the repetitive calculation of the variables. FIG. 6 shows the second example of correction. In the second example, the second variable yᵢ is calculated first and the first variable xᵢ is calculated second. After the calculation of the second variable yᵢ (step S130), the CPU 201 determines whether or not the value of the variable xᵢ(t−dt) is outside the acceptance range in step S152. If it is inside the acceptance range (No in step S152), the CPU 201 calculates the value of the variable xᵢ(t) in step S126. If it is outside the acceptance range (Yes in step S152), the CPU 201 corrects the value of the variable xᵢ(t−dt) to be close or inside the acceptance range in step S154. After the correction step S154, the CPU 201 calculates the value of the variable xᵢ(t) in step S126, based on the corrected value.

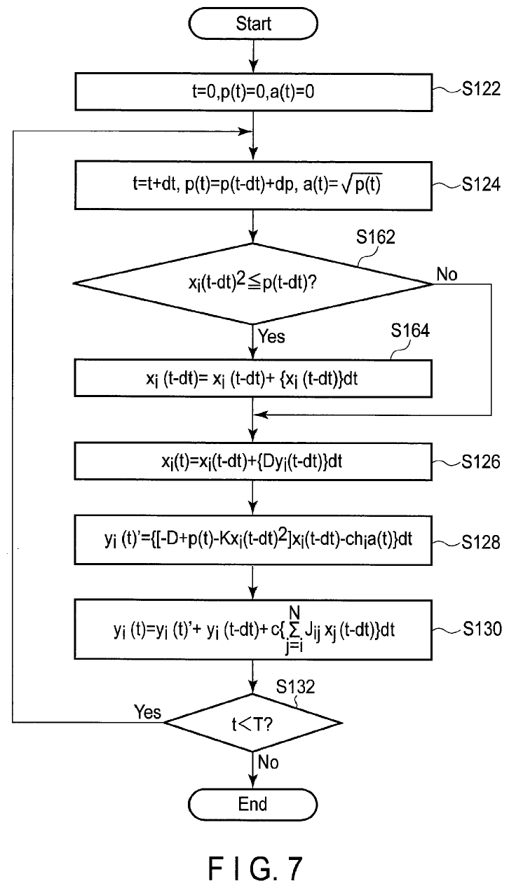

FIG. 7 shows the third example of correction. In the following examples, the correction is performed before the repetitive calculation of the variables, in the same manner as the first example. However, as shown in the second example of FIG. 6, the correction can be performed during the repetitive calculation of the variables. The following examples can be modified by correcting the value of the variable xᵢ during the repetitive calculation of the variables. In the third example, after the increment step S124, the CPU 201 determines whether or not the value of the variable xᵢ(t−dt)² calculated in the previous calculation step is equal to or smaller than p(t−dt) in step S162. Stated another way, the acceptance range is a range in which the value of the variable xᵢ(t−dt) is equal to or larger than +\sqrt{p(t)} or the value of the variable xᵢ(t−dt) is equal to or smaller than −\sqrt{p(t)}.

If the value of the variable xᵢ(t−dt)² is equal to or smaller than p(t−dt) (Yes in step S162), it is regarded that the value of the variable xᵢ(t−dt) is between two local minimum values of the evaluation function.

Therefore, the CPU 201 corrects the value of the variable xᵢ(t−dt) as follows in step S164.

xᵢ(t−dt)=xᵢ(t−dt)+{xᵢ(t−dt)}dt

By this correction, the value of the variable xᵢ(t−dt) is shifted to be far from 0, i.e., to be close to −\sqrt{p(t)} or +\sqrt{p(t)} (or close to the acceptance range).

After the correction step S164, the CPU 201 calculates the value of the variable xᵢ(t) in the current calculation step in step S126, based on the corrected value.

If the value of the variable xᵢ(t−dt)² is larger than p(t−dt) (No in step S162), the CPU 201 does not corrects the value of the variable xᵢ(t−dt) and calculates the value of the variable xᵢ(t) in step S126, based on the non-corrected value.

At the start of operation of the CPU 201, such as the operation of FIG. 7 as well as FIG. 3, FIG. 5, and FIG. 6, it may be preferable that the correction does not interfere with the variable value calculation operation and the effect of the correction becomes large as the operation proceeds. Thus, the following points may be considered when implementing the foregoing correction processing (steps S162 and S164).

(1) At the start of operation of the CPU 201, it may be preferable to implement the determination step S162 so that the value of the first variable xᵢ is inside the acceptable range.

(2) At the start of operation of the CPU 201, it may be preferable to implement the correction step S164 so that the value of the first variable xᵢ is not affected by the correction.

(3) Steps S162 and S164 may be so implemented that their operations (operating modes) vary in accordance with the time t.

(4) Instead of \sqrt{p(t)}, a(t) can be used.

In the same manner as the second example of FIG. 6, the variable yᵢ may be calculated first, the first variable xᵢ may be calculated second, and the correction (steps S162 and S164) may be performed between the calculation of the second variable yᵢ (step S130) and the calculation of the first variable xᵢ (step S126).

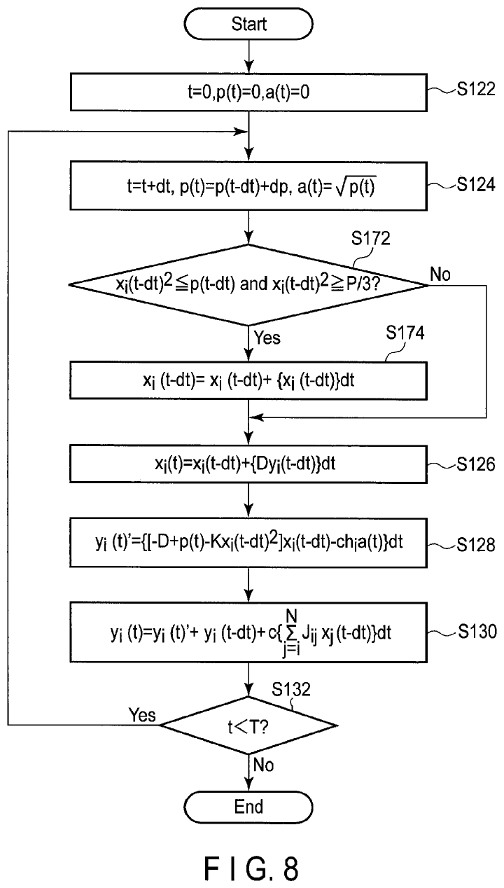

FIG. 8 shows the fourth example of correction.

In the fourth example, after the increment step S124, the CPU 201 determines whether or not the value of the variable xᵢ(t−dt)² calculated in the previous step is equal to or smaller than p(t−dt) and whether or not the value of the variable xᵢ(t−dt)² is equal to or larger than P/3 in step S172. P represents a particular value and may be the value of the coefficient p(t) at the time t of T, i.e., P=dpT/dt.

If the value of the variable xᵢ(t−dt)² is equal to or smaller than p(t−dt) and if the value of the variable xᵢ(t−dt)² is equal to or larger than P/3 (Yes in step S172), the CPU 201 corrects the value of the variable xᵢ(t−dt) in step S174 in the same manner as step S164 of FIG. 7. Even if the value of the variable xᵢ(t−dt)² is equal to or smaller than p(t−dt), the CPU 201 does not correct the value of the variable xᵢ(t−dt) if the value of the variable xᵢ(t−dt)² is not larger than P/3.

After the correction step S174, the CPU 201 calculates the value of the variable xᵢ(t) in the current calculation step in step S126, based on the corrected value.

If the value of the variable xᵢ(t−dt)² is larger than p(t−dt) or if the value of the variable xᵢ(t−dt)² is smaller than P/3 (No in step S172), the CPU 201 does not correct the value of the variable xᵢ(t−dt) and calculates the value of the variable xᵢ(t) in step s126, based on the non-corrected value.

In the same manner as the second example of FIG. 6, the variable yᵢ may be calculated first, the first variable xᵢ may be calculated second, and the correction (steps S172 and S174) may be performed between the calculation of the second variable yᵢ (step S130) and the calculation of the first variable xᵢ (step S126).

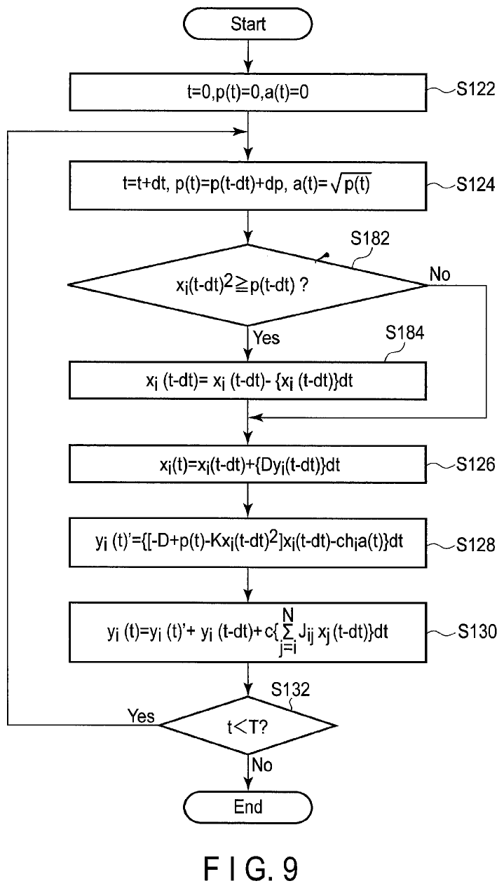

FIG. 9 shows the fifth example of correction. In the fifth example, after the increment step S124, the CPU 201 determines whether or not the value of the variable xᵢ(t−dt)² calculated in the previous calculation step is equal to or larger than p(t−dt) in step S182. If the value of the variable xᵢ(t−dt)² is equal to or larger than p(t−dt) (Yes in step S182), the CPU 201 corrects the value of the variable xᵢ(t−dt) as follows in step S184.

xᵢ(t−dt)=xᵢ(t−dt)−{xᵢ(t−dt)}dt

By this correction, the value of the variable xᵢ(t−dt) is shifted to be close to 0, i.e., to be close to −\sqrt{p(t)} or +\sqrt{p(t)} (or close to the acceptance range).

After the correction step S184, the CPU 201 calculates the value of the variable xᵢ(t) in the current calculation step in step S126, based on the corrected value.

If the value of the variable xᵢ(t−dt)² is smaller than p(t−dt) (No in step S182), the CPU 201 does not correct the value of the variable xᵢ(t−dt) and calculates the value of the variable xᵢ(t) based on the non-corrected value in step S126.

In the same manner as the second example of FIG. 6, the variable yᵢ may be calculated first, the first variable xᵢ may be calculated second, and the correction (steps S182 and S184) may be performed between the calculation of the second variable yᵢ (step S130) and the calculation of the first variable xᵢ (step S126).

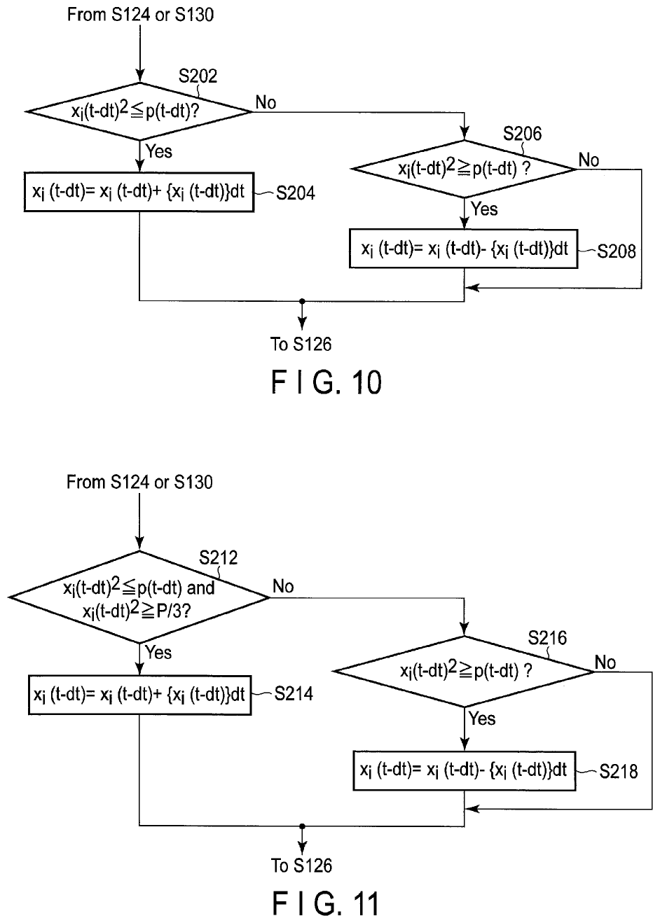

FIG. 10 shows the sixth example of correction which is a combination of the third example of FIG. 7 and the fifth example of FIG. 9. In the sixth example, after the increment step S124, the CPU 201 determines whether or not the value of the variable xᵢ(t−dt)² calculated in the previous calculation step is equal to or smaller than p(t−dt) in step S202. If the value of the variable xᵢ(t−dt)² is equal to or smaller than p(t-dt) (Yes in step S202), the CPU 201 corrects the value of the variable xᵢ(t−dt) as follows in step S204.

xᵢ(t−dt)=xᵢ(t−dt)+{xᵢ(t−dt)}dt

After the correction step S204, the CPU 201 calculates the value of the variable xᵢ(t) in the current calculation step in step S126, based on the corrected value.

If the value of the variable xᵢ(t−dt)² is larger than p(t−dt) (No in step S202), the CPU 201 determines whether or not the value of the variable xᵢ(t−dt)² is equal to or larger than p(t−dt) in step S206. If the value of the variable xᵢ(t−dt)² is equal to or larger than p(t−dt) (Yes in step S206), the CPU 201 corrects the value of the variable xᵢ(t−dt) as follows in step S208.

xᵢ(t−dt)=xᵢ(t−dt)−{xᵢ(t−dt)}dt

After the correction step S208, the CPU 201 calculates the value of the variable xᵢ(t) in step S126, based on the corrected value.

If the value of the variable xᵢ(t−dt)² is smaller than p(t−dt) (No in step S206), the CPU 201 does not correct the value of the variable xᵢ(t−dt) and calculates the value of the variable xᵢ(t) in step S126, based on the non-corrected value.

In the same manner as the second example of FIG. 6, the variable yᵢ may be calculated first, the first variable xᵢ may be calculated second, and the correction (steps S202 to S208) may be performed between the calculation of the second variable yᵢ (step S130) and the calculation of the first variable xᵢ (step S126).

FIG. 11 shows the seventh example of correction which is a combination of the fourth example of FIG. 8 and the fifth example of FIG. 9. In the seventh example, after the increment step S124, the CPU 201 determines whether or not the value of the variable xᵢ(t−dt)² calculated in the previous calculation step is equal to or smaller than p(t−dt) and whether or not the value of the variable xᵢ(t−dt)² is equal to or larger than P/3 in step S212. If the value of the variable xᵢ(t−dt)² is equal to or smaller than p(t−dt) and if the value of the variable xᵢ(t−dt)² is equal to or larger than P/3 (Yes in step S212), the CPU 201 corrects the value of the variable xᵢ(t−dt) as follows in step S214.

xᵢ(t−dt)=xᵢ(t−dt)+{xᵢ(t−dt)}dt

After the correction step S214, the CPU 201 calculates the value of the variable xᵢ(t) in the current calculation step in step S126, based on the corrected value.

If the value of the variable xᵢ(t−dt)² is larger than p(t−dt) or if the value of the variable xᵢ(t−dt)² is smaller than P/3 (No in step S212), the CPU 201 determines whether or not the value of the variable xᵢ(t−dt)² is equal to or larger than p(t−dt) in step S216. If the value of the variable xᵢ(t−dt)² is equal to or larger than p(t−dt) (Yes in step S216), the CPU 201 corrects the value of the variable xᵢ(t−dt) as follows in step S218.

xᵢ(t−dt)=xᵢ(t−dt)−{xᵢ(t−dt)}dt

After the correction step S218, the CPU 201 calculates the value of the variable xᵢ(t) in step S126, based on the corrected value.

If the value of the variable xᵢ(t−dt)² is smaller than p(t−dt) (No in step S216), the CPU 201 does not correct the value of the variable xᵢ(t−dt) and calculates the value of the variable xᵢ(t) in step S126, based on the non-corrected value.

In the same manner as the second example of FIG. 6, the variable yᵢ may be calculated first, the first variable xᵢ may be calculated second, and the correction (steps S212 to S218) may be performed between the calculation of the second variable yᵢ (step S130) and the calculation of the first variable xᵢ (step S126).

The aspects of the data processing apparatus 300 according to the embodiment described above will be summarized. The data processing apparatus 300 is equipped with the input device 101, arithmetic operation device 200, and output device 102.

(Aspect A1)

The input device 101 can set at least a first set of variables (xᵢ=x₁₁ to x_{1N}). The arithmetic operation device 200 performs a process using recurrence equations Eq. 6B and Eq. 7B as shown in FIG. 4.

More specifically, the arithmetic operation device 200 performs a first process through an M-th process (M is a positive integer) repetitively so as to process at least the first set of variables (xᵢ=x₁₁ to x_{1N}) based upon the recurrence equation Eq. 6B, process at least a second set of variables (xᵢ=x₂₁ to x_{2N}), which is obtained in the first process, based on the recurrence equation Eq. 6B, process at least a third set of variables (xᵢ=x₃₁ to x_{3N}), which is obtained in the second process, based on the recurrence equation Eq. 6B, and finally process at least an M-th set of variables.

The arithmetic operation device 200 implements a determination unit configured to determine whether a difference between each of the values of the variables calculated in each calculation step and a particular value is larger than a first value. The arithmetic operation device 200 is configured to correct the value of the variables calculated in the previous calculation step to be close to the particular value and calculate a value of the variables in the current calculation step using a corrected value of the variables if the difference between the value of the variables calculated in the previous calculation step and the particular value is larger than the first value. The variables can thus converge to +1 or −1 quickly.

(Aspect A2)

In aspect A1, each of the recurrence equations comprises a coefficient, and the particular value relates to the coefficient.

(Aspect A3)

In aspect A1, arithmetic operation device 200 is further configured to determine whether each of the values of the variables calculated in the each calculation step is inside a particular value range, and the arithmetic operation device 200 does not correct a value of the variables calculated in the previous calculation step if the value of the variables calculated in the previous calculation step is inside the particular range.

(Aspect A4)

In aspect A1, the arithmetic operation device 200 is further configured to determine whether a polarity of the difference is positive or negative and whether each of the values of the variables calculated in the each calculation step is inside an particular range, and the arithmetic operation device 200 is further configured to correct the succeeding value of the variables in the previous calculation step in a negative direction or a positive direction based on the polarity of the difference if the value of the variables calculated in the previous calculation step is outside the particular range.

(Aspect B1)

The input device 101 can set at least the first set of variables (xᵢ=x₁₁ to x_{1N}), and the arithmetic operation device 200 performs a process using recurrence equations Eq. 6B and Eq. 7B as shown in FIG. 4.

The following processing method and programs can be provided. The arithmetic operation device 200 performs a first process through an M-th process (M is a positive integer) repetitively so as to process at least the first set of variables (xᵢ=x₁₁ to x_{1N}) based upon the recurrence equation Eq. 6B, process at least a second set of variables (xᵢ=x₂₁ to x_{2N}), which is obtained in the first process, based on the recurrence equation Eq. 6B, process at least a third set of variables (xᵢ=x₃₁ to x_{3N}), which is obtained in the second process, based on the recurrence equation Eq. 6B, and finally process at least an M-th set of variables. When the arithmetic operation device 200 performs the above calculation, the arithmetic operation device 200 determines whether a difference between each of the values of the variables xᵢ calculated in each calculation step and a particular value is larger than a first value. The arithmetic operation device 200 corrects the value of the variables calculated in the previous calculation step to be close to the particular value and calculates a value of the variables xᵢ in the current calculation step using a corrected value of the variables if the difference between the value of the variables calculated in the previous calculation step and the particular value is larger than the first value.

(Aspect C1)

The data processing apparatus 300 includes the input device 101, the arithmetic operation device 200, and the output device 102. The input device 101 can set at least a first set of variables (xᵢ=x₁₁ to x_{1N}) and a second set of variables (Yᵢ=Y₁₁ to Y_{1N}). The first set of variables xᵢ relates to a plurality of objects. The second set of variables yᵢ includes a mutual coefficient Jⱼᵢ between a pair of objects among the plurality of objects.

The arithmetic operation device 200 performs a process using recurrence equations Eq. 6B and Eq. 7B as shown in FIG. 4.

More specifically, the arithmetic operation device 200 performs a first process through an M-th process (M is a positive integer) cyclically so as to process at least the first set of variables (xᵢ=x₁₁ to x_{1N}) and second variables (yᵢ=Y₁₁ to Y_{1N}) based upon the recurrence equation, process at least a second set of variables (xᵢ=x₂₁ to x_{2N}) and second variables (yᵢ=y₂₁ to y_{2N}), which is obtained in the first process, based on the recurrence equation, process at least a third set of variables (xᵢ=x₃₁ to x_{3N}) and second variables (yᵢ=y₃₁ to y_{3N}), which is obtained in the second process, based on the recurrence equation, and finally process an M-th set of variables.

The arithmetic operation device 200 implements a determination unit configured to determine whether a difference between each of the values of the variables calculated in each calculation step and a particular value is larger than a first value. The arithmetic operation device 200 is configured to correct the value of the variables calculated in the previous calculation step to be close to the particular value and calculate a value of the variables in the current calculation step using a corrected value of the variables if the difference between the value of the variables calculated in the previous calculation step and the particular value is larger than the first value. The variables can thus converge to +1 or −1 quickly.

At least a part of the first set of variables xᵢ may correspond to one or more target objects (which may be determined in advance or newly detected) or predetermined objects that are pre-selected or designated by some method.

In the process of repetitive calculation using a recurrence equation which is to be performed in the arithmetic operation device 200, it may possible to detect the convergence states of the first and second variables xᵢ and yᵢ from the state where the value of the evaluation function H′ becomes the minimum (or the maximum). Then, it may possible to generate and output related data indicating the relationship between the target objects and the predetermined objects based upon the converged value of the variables.

(Aspect C2)

One example of the related data may be data for specifying a route object from the predetermined objects to determine a route from the predetermined objects (e.g., a starting position, the location of a police station and the location of a fire station) to the target objects (e.g., a patrol destination, an ignition location and a trouble location).

(Aspect C3)

Another example of the related data may be data for specifying a placement object of the predetermined targets from the predetermined objects in which a placement object is optimum for the target objects (e.g., a patrol destination, an ignition location, and a trouble location).

(Aspect C4)

The related data of the aspects C1 to C4 may be transmitted to the display device of a mobile terminal.

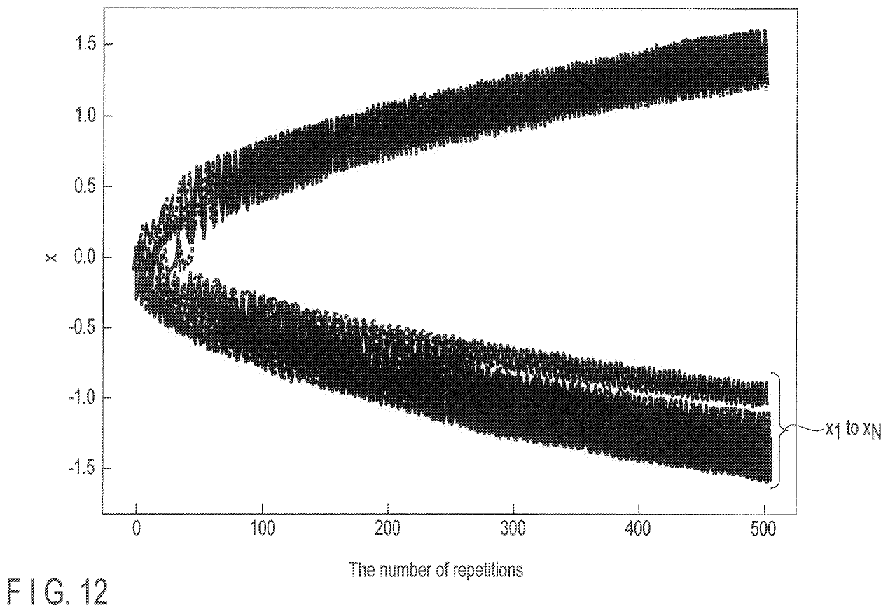

FIG. 12 to FIG. 16 show the relationship between the number t of repetitive calculations of the recurrence equation and the value of a value of the variable xᵢ in the evaluation function processing in the CPU 201 (repetitive calculation processing of the recurrence equation). In FIG. 12 to FIG. 16, repetitive calculations are performed for each set (variables x₁ to x_{N}) a locus (x₁₁ to x_{1N}, x₂₁ to x_{2N}, x₃₁ to x_{3N}, . . . x_{M1} to x_{MN}) of the values of the value of the variables are drawn.

FIG. 12 shows an example in which the correction is not performed. As is apparent from FIG. 12, the values of the values of the variables xᵢ are difficult to converge to a(t) or −a(t). That is, even though the repetitive calculation using the recurrence equation is performed 500 times, the values do not converge toward xₘᵢ=a(t) or xₘᵢ=−a(t).

FIG. 13 to FIG. 16 show a locus (x₁₁ to x_{1N}, x₂₁ to x_{2N}, x₃₁ to x_{3N}, . . . x_{M1} to x_{MN}) of the values of the values of the variable x₁ when the values of the values of the variable x₁ are corrected.

FIG. 13 shows results of repetitive calculations when the values of the values of the variable x are corrected in the same manner as the third example shown in FIG. 7. In the process of about 50 repetitive calculations using a recurrence equation, xₘᵢ varies within a range of −0.5<xₘᵢ<+0.5 and does not converge. However, when the number of repetitions of the repetitive calculation exceeds about 200, xₘᵢ satisfactorily converges to xₘᵢ=a(t) or xₘᵢ=−a(t).

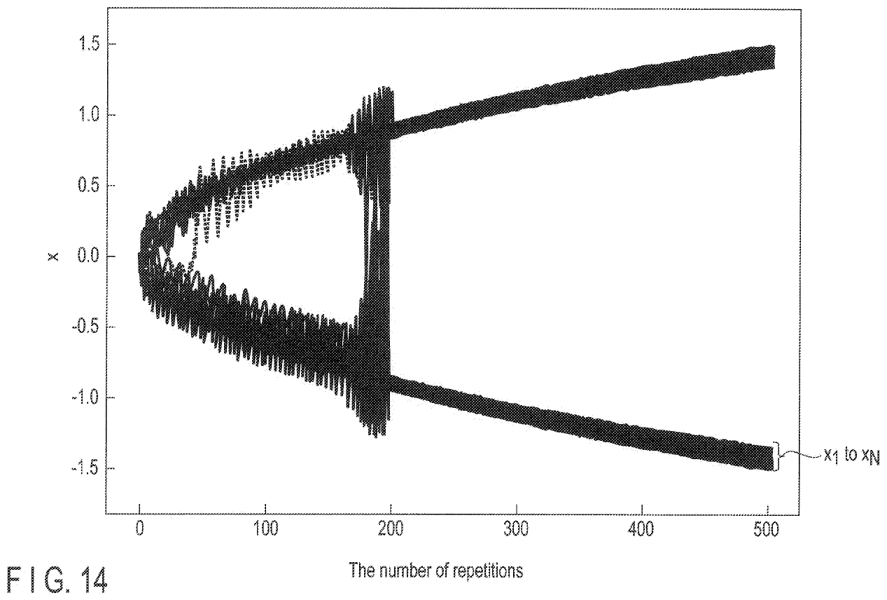

FIG. 14 shows processing results of the calculation unit when the values of the values of the variable x are corrected in the same manner as the fourth example shown in FIG. 8. In the process of about 200 repetitive calculations using a recurrence equation, xᵢ varies within a range of −0.5<xᵢ<+0.5 and does not converge. However, when the number of repetitions of the repetitive calculation exceeds about 200, xₘᵢ satisfactorily converges to xₘᵢ=+a(t) or xₘᵢ=−a(t).

According to the calculation as shown in FIG. 14, the advantage of the correction processing appears when the number of repetitions of the repetitive calculation has exceeded about 200. Since the advantage of the correction processing does not appear immediately after the start of the calculation, it does not interfere with the operation of searching for the value of the variable in the initial stage of the repetitive calculation. The effectiveness of search for the global minimum value can thus be expected.

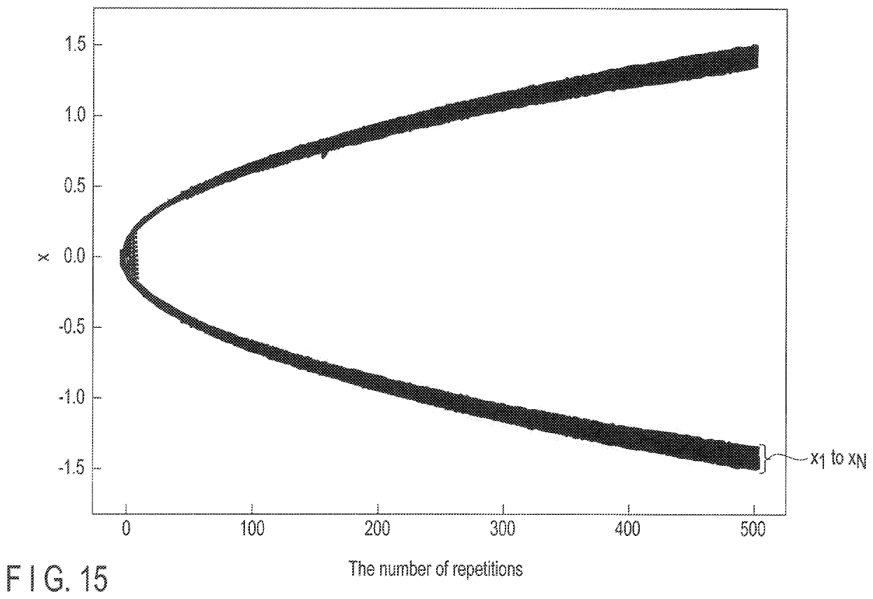

FIG. 15 shows calculation results obtained when the values of the values of the variable x are corrected in the same manner as the sixth example shown in FIG. 10. The values come close to the optimum value in the initial stage of the repetitive calculation using the recurrence equation. When the number of repetitions of the repetitive calculation has exceeded, e.g., about 200, the values smoothly converge to xₘᵢ=+a(t) or xₘᵢ=−a(t). Therefore, the effectiveness of this embodiment can be expected when priority is given to search for an appropriate solution.

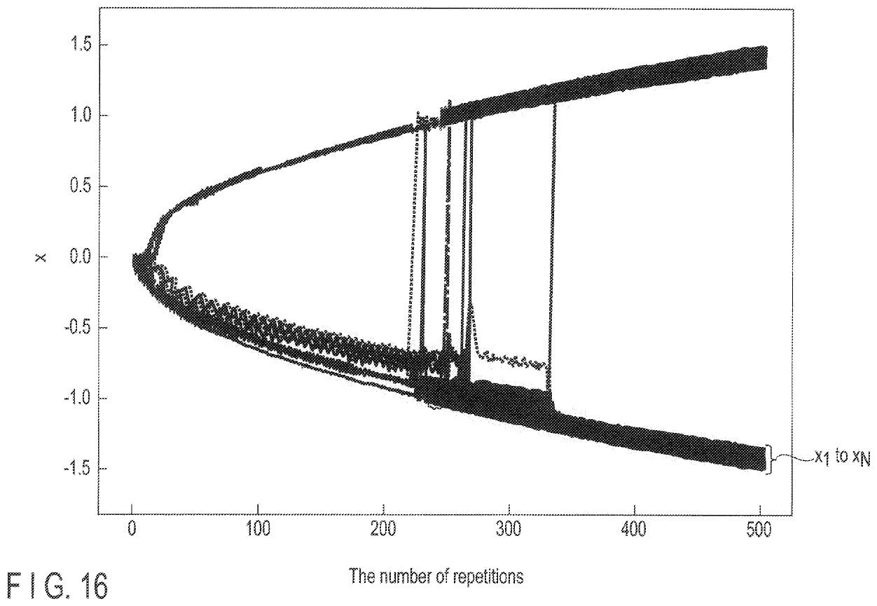

FIG. 16 shows repetitive calculation results obtained when the values of the values of the variable x are corrected in the same manner as the seventh example shown in FIG. 11.

When the number of repetitions of the repetitive calculation has exceeded, e.g., about 340, the values tend to smoothly converge to xₘᵢ=a(t) or xₘᵢ=−a(t). Since the embodiment has this feature, it exhibits the behavior of delaying time when the value of the values of the variable xi are determined as xₘᵢ=a(t) or xₘᵢ=−a(t).

As described above, the value convergence in the data processing apparatus 300 exhibits a characteristic behavior for each of the examples. Thus, the correction processing steps of different types shown in FIG. 5 to FIG. 11 are implemented, and may be used alone or in combination depending on the intended use. This brings about the advantage that a flexible system can be provided.

The foregoing system can be applied to a device for determining a combined solution in various fields. A coefficient setting device to provide the evaluation function H′ with coefficients, an attribute information processor to add attribute information to the variable, etc., may be connected to the arithmetic operation device 200 directly or via a network. The coefficients and attribute information are set optionally in accordance with the environment and purpose of using the system. For example, the coefficients p, c, and h may be set by the coefficient setting device such that they can be changed automatically or optionally (or can be selected). Also, the value of the value of the variable may forcibly be set to +1 or −1 in accordance with the environment and purpose of using the system and the attribute information on the variable.

According to one embodiment, a predetermined function (evaluation function H′) including a plurality of variables or an equation derived therefrom is adaptively processed to obtain an equation that substantially allows a discretized variables solution. Using the discretized variables solution, a data processing apparatus or a data processing method capable of high-speed and high-reliability calculation is provided.

According to another embodiment, a constraint term or an initialization term of a specific variable is added to the foregoing equation. Thus, a data processing apparatus or a data processing method that is improved in calculation convergence speed or calculation result reliability is provided.

The values of a plurality of variables are calculated using a recurrence equation derived from the above evaluation function H′. When a value of the variable, which is generated in the process of the calculation, is shifted by a given value or more from the predicted value, a slight correction is performed for the value to bring it close to the predicted value. As a result, a data processing apparatus or a data processing method that is improved in the reliability of the solution is provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. (canceled)

2. A data processing apparatus comprising:
a processor configured to perform a processing procedure to solve an Ising problem by calculating values of Ising spins to minimize an Ising energy,
wherein
the processing procedure includes a first variable update and a second variable update,
the first variable update includes updating an ith solution of a first variable xᵢ by adding a first function to the ith solution of the first variable xᵢ, i being an integer not less than one and not more than N, and N being an integer of two or more,
the ith solution of the first variable xᵢ is one of a set of first variables {xᵢ},
a variable of the first function includes the ith solution of a second variable yᵢ,
the ith solution of the second variable yᵢ is one of a set of second variables {yᵢ},
the second variable update includes updating the ith solution of the second variable yᵢ by adding a second function and a third function to the ith solution of the second variable yᵢ,
a variable of the second function is the ith solution of the first variable xᵢ,
variables of the third function include at least a part of a set of parameters {J} and at least a part of the set of the first variables {xᵢ},
the processor is configured to determine whether the ith solution of the first variable xᵢ is in a first range of the ith solution of the first variable xᵢ,
the processor is configured to change the ith solution of the first variable to a correction value when the ith solution of the first variable xᵢ is not in the first range,
the correction value is a value in the first range, and
the ith solution of the first variable corresponds to one of the values of the Ising spins.

3. The data processing apparatus of claim 2, wherein
the first range is between a positive first value and a negative second value, and
the correction value is a value close to one of the first value and the second value.

4. The data processing apparatus of claim 3, wherein
the positive first value is a positive ideal value of the first variable xᵢ and the negative first value is a negative ideal value of the first variable xᵢ.

5. The data processing apparatus of claim 2, wherein
the first range is between a positive first value and a negative second value, and
the correction value is one of the first value and the second value.

6. The data processing apparatus of claim 5, wherein
the positive first value is a positive ideal value of the first variable xᵢ and the negative first value is a negative ideal value of the first variable xᵢ.

7. The data processing apparatus of claim 2, wherein
the second function includes a coefficient,
the value of the coefficient is updated by a coefficient update,
a binarized value of the ith solution of the first variable is +1 or −1 when the coefficient is increased to a value larger than a first value.

8. The data processing apparatus of claim 7, wherein
the first range is between a positive root of the coefficient and a negative root of the coefficient.

9. A data processing method comprising:
performing a processing procedure to solve an Ising problem by calculating values of Ising spins to minimize an Ising energy by at least one processor,
wherein
the processing procedure includes a first variable update and a second variable update,
the first variable update includes updating an ith solution of a first variable xᵢ by adding a first function to the ith solution of the first variable xᵢ, i being an integer not less than one and not more than N, and N being an integer of two or more,
the ith solution of the first variable xᵢ is one of a set of first variables {xᵢ},
a variable of the first function includes the ith solution of a second variable yᵢ,
the ith solution of the second variable yi is one of a set of second variables {yᵢ},
the second variable update includes updating the ith solution of the second variable yᵢ by adding a second function and a third function to the ith solution of the second variable yi,
a variable of the second function is the ith solution of the first variable xᵢ,
variables of the third function include at least a part of a set of parameters {J} and at least a part of the set of the first variables {xᵢ},
the at least one processor is configured to whether the ith solution of the first variable xi is in a first range of the ith solution of the first variable xᵢ,
the at least one processor is configured to change the ith solution of the first variable to a correction value when the ith solution of the first variable xᵢ is not in the first range,
the correction value is a value in the first range, and
the ith solution of the first variable corresponds to one of the values of the Ising spins.

10. The data processing method of claim 9, wherein
the first range is between a positive first value and a negative second value, and
the correction value is a value close to one of the first value and the second value.

11. The data processing method of claim 10, wherein
the positive first value is a positive ideal value of the first variable xᵢ and the negative first value is a negative ideal value of the first variable xᵢ.

12. The data processing method of claim 9, wherein
the first range is between a positive first value and a negative second value, and
the correction value is one of the first value and the second.

13. The data processing method of claim 11, wherein
the positive first value is a positive ideal value of the first variable xᵢ and the negative first value is a negative ideal value of the first variable xᵢ.

14. The data processing method of claim 9, wherein
the second function includes a coefficient,
the value of the coefficient is updated by a coefficient update,
a binarized value of the ith solution of the first variable is +1 or −1 when the coefficient is increased to a value larger than a first value.

15. The data processing method of claim 14, wherein
the first range is between a positive root of the coefficient and a negative root of the coefficient.
